(19) United States
(12) Patent Application Publication
(10) Pub. No.: US 2011/0091844 A1
(43) Pub. Date: Apr. 21, 2011

(54) VIRTUAL BOOK

(76) Inventor: Roger J. Best, Eugene, OR (US)

(21) Appl. No.: 12/582,418

(22) Filed: Oct. 20, 2009

(51) Int. Cl. G09B 23/02; G06F 3/048; G06F 12/00; G09B 5/00

(52) U.S. Cl. 434/188; 715/771; 711/154; 434/307 R; 711/E12.001

(57) ABSTRACT

Computer-readable media, virtual books and methods are provided for teaching, learning and simulating mathematical principles. One or more pages of a plurality of pages of a virtual book that resembles a tangible book may be depicted on an electronic display. Data may be received on one or more of the pages. The data received may be dynamically charted in the virtual book to facilitate interactive learning and application with user data.

### BACKGROUND

Mathematical principles are often taught using tangible books with pages made of paper. For example, disciplines that are math-intensive, such as algebra, mechanical engineering, economics and calculus are taught at schools using tangible textbooks. In the business world, business principles such as corporate finance, micro- and macro-economics and marketing metrics are taught using tangible books, such as workbooks handed out at seminars or more traditional business textbooks. However, the static nature of tangible books makes them difficult to use for developing insight and for application to changing business situations, particularly when a quick answer to an executive-level question is desired.

Software exists that allows the manipulation and application of mathematical principles. For example, spreadsheet software allows a user to create tables and charts based on data that are input into cells. However, spreadsheet software requires a high level of skill and familiarity and is ill-suited for teaching mathematical principles. Accordingly, spreadsheet software is not suitable for executive use, particularly when dealing with unfamiliar and/or complex mathematical principles, such as marketing metrics. Moreover, although spreadsheet software is highly flexible, this flexibility also provides considerable room for unintended complexity and greater potential for error.

### BRIEF DESCRIPTION OF THE DRAWINGS

FIG. 1 depicts a method of teaching, interactive learning and applying mathematical principles according to an embodiment of the disclosure.

FIG. 2 is a view of a virtual book for interactive learning and user application of marketing metrics, according to an embodiment of the disclosure.

FIGS. 3 and 4 depict a portion of a virtual book page before and after the portion is selected for page-turning, according to an embodiment of the disclosure.

FIG. 5 depicts example dynamic charts and graphics of a virtual book according to an embodiment of the disclosure.

FIG. 6 depicts example source data for the charts of FIG. 5.

FIG. 7 depicts a data-save interface according to an embodiment of the disclosure.

FIG. 8 depicts a digital tab that can be made visible to give access to a network resource (e.g., a webpage), according to an embodiment of the disclosure.

FIG. 9 depicts a digital tab that can be made visible to edit current information contained in the plurality of cells, according to an embodiment of the disclosure.

### DETAILED DESCRIPTION

As used herein, a “virtual book” is a digital representation of a tangible book on an electronic display. Just as a tangible book has physical pages made of paper, a virtual book has a plurality of ordered electronic or digital pages through which a user may “turn” in order to reach (i.e., display) a particular page. However, unlike a tangible book, which is static, a virtual book may include portions that can be created, edited, saved and exported to other computer programs. A virtual book may also include dynamic charts that change appearances in response to user input.

In some embodiments, a virtual book is part of a software application that is configured to execute within a virtual machine (e.g., J2EE) or a cross-platform runtime environment (e.g., Adobe Air®). Executives and/or users with little computer experience may find such embodiments easy to install and use. In other embodiments, a virtual book is part of a more traditional computer application that may be compiled for a particular operating environment or computer architecture.

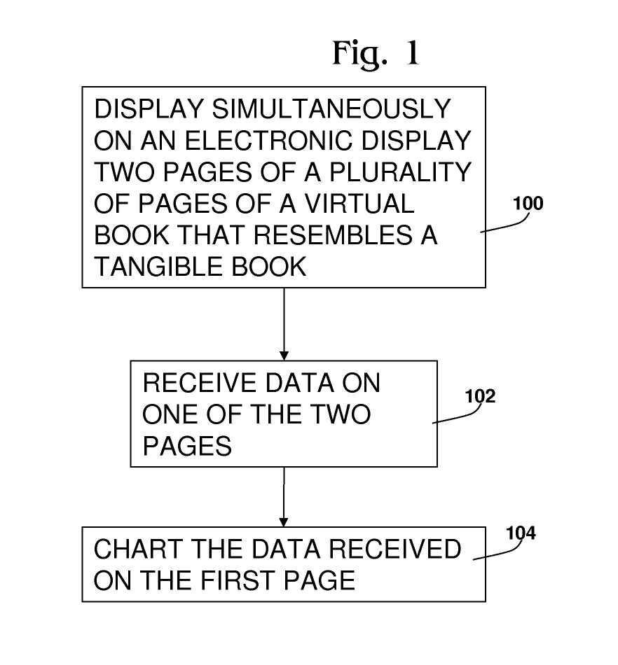

FIG. 1 depicts an example method for teaching, interactive learning and simulating mathematical principles using a virtual book. In step 100, two pages of a plurality of pages are depicted simultaneously on an electronic display such as a computer monitor or a television.

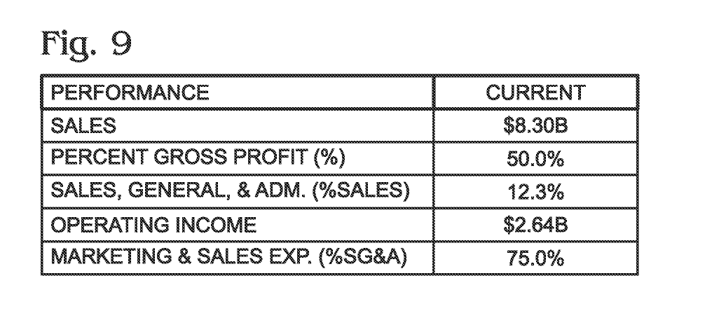

In step 102, data is received on one of the two pages. As noted above, a virtual book may include portions that are editable. Receiving data may include a user inputting data (e.g., numeric data) into editable cells, as will be discussed further below. Receiving data also may include modifying existing data. As will be discussed below with relation to FIG. 9, a user may input data using an alternative user interface. This alternative interface may provide a user with a more robust ability to edit information shown on pages, including allowing a user to edit cells and other information that are not usually editable using the main interface, thus providing for customization of a virtual book.

In step 104, the data received is either charted, or an existing chart is modified to reflect the received data. Virtual books may include various types of charts, including but not limited to traditional bar, line and pie charts, as well as other types of charts that are described below.

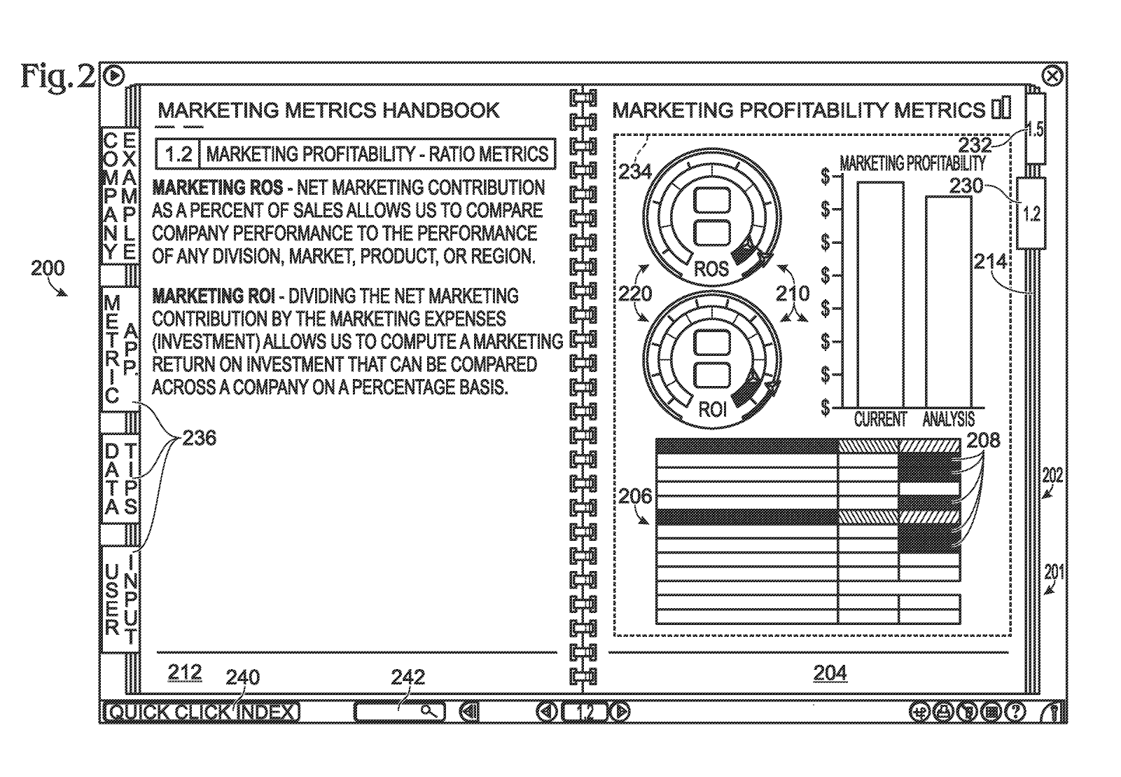

FIG. 2 depicts a graphical user interface 200 that includes a virtual book 201 as it may be depicted on an electronic display. As noted above, virtual book 201 includes a plurality of ordered pages 202. A first page 204 includes one or more cells 206. The one or more cells 206 includes one or more editable cells 208 that may be modified by a user. In some embodiments, editable cells 208 include default data that can be modified. One or more charts 210 are also included on first page 204. A second page 212, shown on the left, includes information about the components of first page 204. It should be understood that in other embodiments, any of the above-described components may be situated on either of first page 204 or second page 212.

Virtual books 201 may be related to any number of mathematical principles. For example, a virtual physics book might have multiple chapters, each devoted to a particular physics principle. A user may be able to input data into one or more cells 206 on each page to cause an associated physics illustration (e.g., animation showing the effect of gravity on moving objects of various masses) to react.

The embodiment of FIG. 2 depicts a virtual book 201 that relates to marketing metrics. Each chapter is devoted to a different marketing metric principle. The data contained in the one or more cells 206 on each page is marketing data, and the charts 210 are configured to depict analysis information about marketing metrics based upon the marketing data in the one or more cells 206 or editable cells 208.

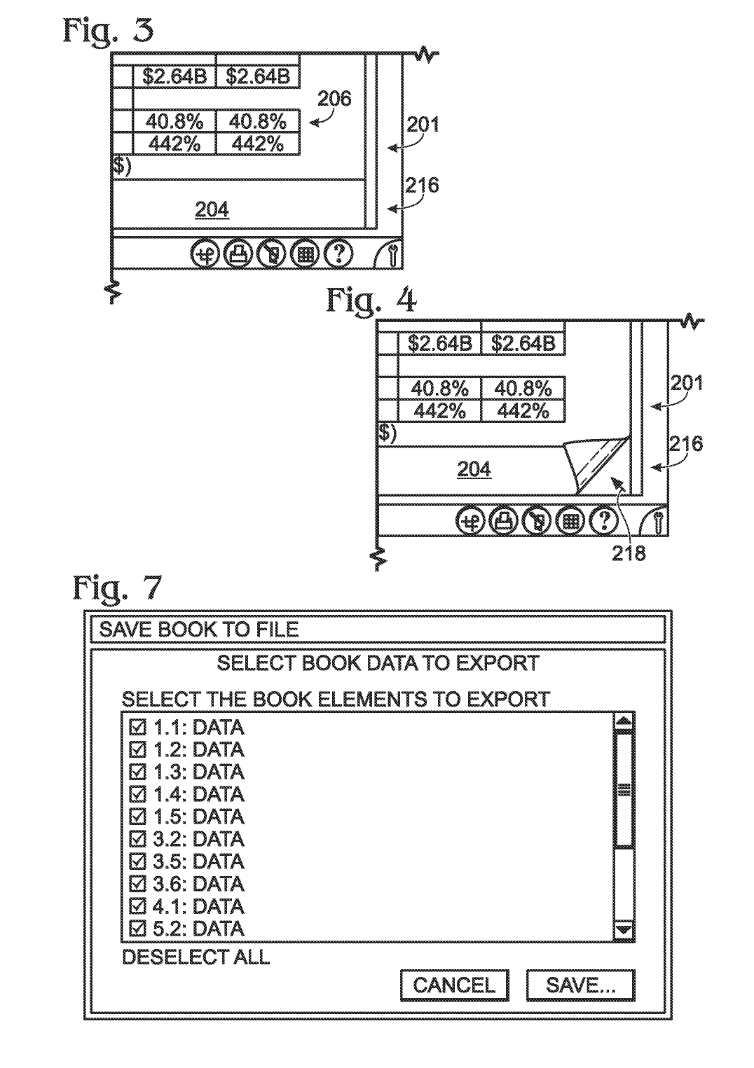

Other pages of plurality of pages 202, such as a third page 214, may be selected for viewing by turning pages of the plurality of ordered pages 202 until third page 214 is viewable. FIGS. 3 and 4 depict a corner of an example virtual book 201 with a corner portion 216 of first page 204 that is configured to transform visibly when a user moves a cursor 218 over corner portion 216 so that the user can “turn” the page. Portion 216 appears in FIG. 3 to be laying flat on top of a page behind first page 204. In FIG. 4, cursor 218 is moved over corner portion 216 (e.g., using a mouse or directional keys on a keyboard), causing corner portion 216 to transform visibly to appear as though it is the corner of a page beginning to be turned. In some embodiments, first page 204 is turned when the transformed corner-like portion 216 is selected (e.g., clicked) to simulate turning a page.

FIG. 5 depicts dynamic dial charts 220 similar to some of the charts 210 shown in FIG. 2. Each dial chart 220 includes an inner dial 222 with an inner indicator 224 that is located at a position along inner dial 222 that is related to (e.g., proportional to) a first value in a first cell of the one or more cells 206. Each dial chart 220 also includes an outer dial 226 with an outer indicator 228 that is located at a position along outer dial 226 that is related to (e.g., proportional to) a second value in a second cell of the one or more cells 206. As will be discussed further below, the first and second cells may be editable cells 208, so that the positions of the inner indicator 224 and outer indicator 228 may be adjusted when a user changes data in the editable cells. In embodiments such as the one shown in FIG. 5, inner dial 222 and outer dial 226 are concentric so that the values represented by inner indicator 224 and outer indicator 228 may be compared easily.

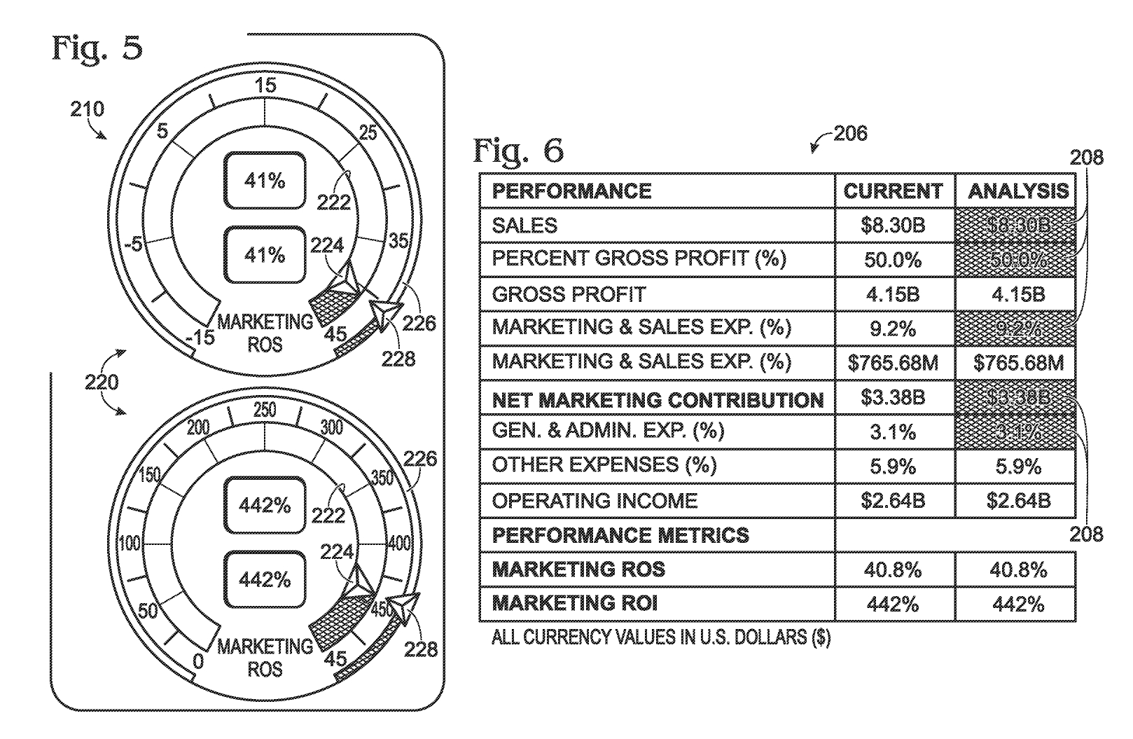

FIG. 6 depicts a table with the source data used to create dial charts 220 in FIG. 5. In this example, the data is marketing metric data relating to market profitability, but this is not meant to be limiting. Two scenarios, “Current” and “Analysis,” are shown. “Current” represents baseline data as it exists in the real world. “Analysis” allows a user to compare the “Current” data to hypothetical data. Accordingly, there are a number of editable cells 208 under the “Analysis” scenario that can be modified to change the appearance of the dial charts 220 of FIG. 5. In FIG. 6, none of the cells have yet been modified, and so the “Analysis” scenario contains data identical to the “Current” scenario.

In both dial charts 220 of FIG. 5, outer dial 226 represents the “Current” scenario and inner dial 222 represents the “Analysis” scenario. The top dial chart 220 in FIG. 5 is based on the “Marketing ROS” (return on sales) data in the table of FIG. 6. Both inner indicator 224 and outer indicator 228 of the top dial chart 220 are pointed at 41% because that is the value of the “Marketing ROS” cells. The bottom dial chart 220 in FIG. 5 is based on the “Marketing ROI” (return on investment) data in the table of FIG. 6. Both inner indicator 224 and outer indicator 228 of the bottom dial chart 220 are pointed at 442% because that is the value of the “Marketing ROI” cells.

In some embodiments, when a datum in an editable cell 208 is changed, the graphical user interface fluidly animates a change in one or more charts 210, as opposed to changing abruptly from one appearance to the next. For example, a bar chart may gradually and visibly grow or shrink, rather than abruptly changing from a first height to a second height. In the dial charts 220 of FIG. 5, the inner indicator 224 and outer point 228 may move fluidly between two values when a cell containing the source data for these indicators is changed. In some embodiments, when a value in editable cell 208 is increased or decreased, a moving arrow is animated adjacent to chart 210 briefly to demonstrate and draw attention to a specific effect of the increase/decrease on chart 210.

Some embodiments provide the ability to bookmark pages, just as with a tangible book. In FIG. 2, for example, first page 204 is bookmarked with a virtual bookmark 230 so that if a user turns to a different page, the bookmark 230 will remain visible (as depicted by a second bookmark 232 shown in FIG. 2). In some embodiments, bookmarks include text such as the chapter number that is bookmarked. A user may click on a visible bookmark at any time to turn directly to the bookmarked page.

Some embodiments provide the ability to select all or a portion of one or more pages and save the selected portion directly to memory as an image file, rather than saving the selected portion to the clipboard first and then pasting the clipboard contents into another file to be saved to memory. In FIG. 2, for example, a portion of the screen is selected to be copied with a selection box 234. Once portion is selected, a user may be asked whether he or she would like to save the selected portion directly to memory or to the clipboard. The selected portion may be saved to memory in any number of image formats, such as JPEG, GIF, PNG and the like, although an image format that yields a relatively small file size may be desirable for insertion into an email or into other documents at a later time.

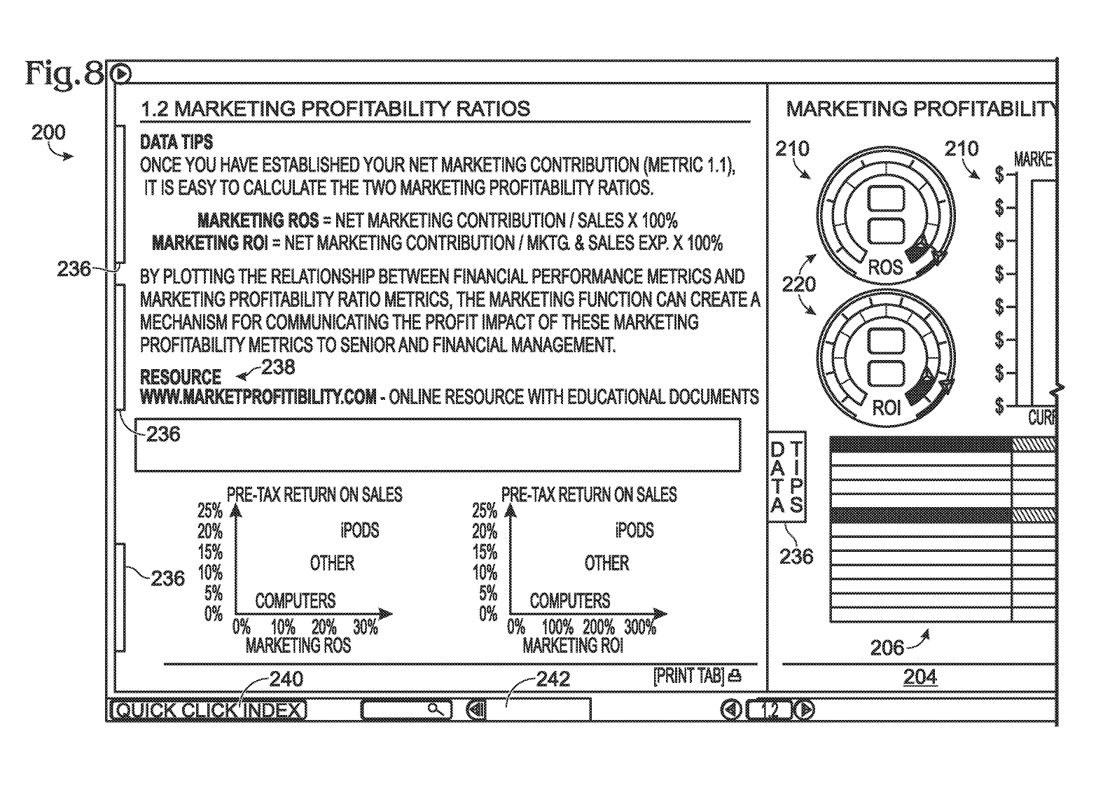

Some embodiments allow for virtual book 201 to be customized. For example, data that has been input into editable cells 208 during a current session of using virtual book 201 may be saved to memory. Likewise, data input into editable cells 208 during a previous session of using virtual book 201 may be reloaded into virtual book 201 at a later time. FIG. 7 depicts a prompt according to one embodiment that depicts possible subsets of data (organized into chapters) that can be saved. Some embodiments additionally or alternatively allow data input into editable cells 208 to be exported to/imported from other applications, such as spreadsheets or databases.

Virtual books may be customized in other ways. For example, default logos depicted on pages of the book may be replaced with company or custom logos. Currency symbols may be adjusted, which causes some embodiments to change currency data to reflect exchange rates that are either programmed into the virtual book or retrieved from a network resource.

In some embodiments, such as the ones shown in FIGS. 2 and 8, virtual book 201 includes one or more tabs 236 that may be selected by a user to access various resources. In FIG. 2, there are four tabs, entitled “Company Example,” “Metric Application,” “Data Tips” and “User Input.” If a user selects (e.g., clicks) any one of these tabs, the tab appears to slide over the left-facing second page 212 to depict information. For example, the “Company Example” tab 236 may be selected to depict information about an example company to teach and illustrate how the marketing metric that is the subject of the current chapter is utilized in the real world. The “Metric App.” (Metric Application) tab 236 may be selected to depict general background information about that chapter marketing metric.

As shown in FIG. 8, the “Data Tips” tab 236 may be selected to depict tips on how to use the particular marketing metric data of the chapter. The “Data Tips” tab in this example also includes a link 238 to a network resource that is related to the subject matter of the chapter.

It should be understood that while the specific example shown in FIGS. 2 and 8 and described above relates to marketing metrics, similar components could be used with virtual books 201 relating to other mathematical principles. For example, a physics virtual book 201 may have tabs that, when selected, depict information about physics principles and/or allow a user to perform physics practice problems, and may include links 238 to network resources relating to physics.

The “User Input” tab 236 may be selected to show one or more editable cells 208 that are part of the one or more cells 206 on first page 204. In some embodiments, a user may be able to enlarge (i.e., zoom in on) the cells shown in the “User Input” tab 236 to more easily input data into editable cells 208.

FIG. 9 depicts an example interface that may be shown when the “User Input” tab 236 is selected. In this example, the cells on the left under “PERFORMANCE” (e.g., “Sales,” “Percent Gross Profit (%),” “Operating Income”) are editable. These cells may be used to modify the “Current” data in charts such as the chart shown in FIG. 5. By modifying “Current” data in a given chapter, a user may customize virtual book 201 by replacing “Current” data with their own custom baseline data, so that the user may then compare their own custom baseline data with “Analysis” data, as described above. Any changes to “Current” data may be saved, allowing virtual book 201 to evolve as needs change.

Some embodiments include features for quickly moving to a particular location in a virtual book. For example, the virtual book 201 of FIG. 2 includes a “Quick Click Index” 240 that allows a user to reach any location in the plurality of ordered pages 202 in two mouse clicks (or returns on the keyboard). For example, if each chapter is subdivided into subsections (e.g., 2.1, 2.2, 2.3 . . . ), then a user may click on the “Quick Click” index 240 to reveal a list of the main chapters (e.g., 1, 2, 3 . . . ). Moving a cursor 218 over any of the main chapters may reveal a list of subsections of that chapter. The user may then move the cursor 218 over a subsection and select it to turn directly to the page containing that subsection of that chapter.

The embodiment of FIG. 2 also includes a searchable glossary 242 that receives as input a term relevant to the particular virtual book. For example, a user may type the term “market profitability” into the searchable glossary 242 of FIG. 2, and the virtual book 201 may turn automatically to a page of a glossary at the end of the plurality of ordered pages 202 and highlight the searched term.

Some embodiments provide for alpha-numeric data scaling. If a first datum is input into a first editable cell 208 and a second datum of a different order than the first datum (e.g., million versus billion) is input into a second editable cell 208, the first datum and/or the second datum may be scaled (automatically or upon request) to a common order. Some embodiments are configured to ensure that data is scaled so that at least one digit is shown above a decimal point The following table demonstrates some examples of how data may be scaled:

| | Input | Data After Scaling |
|---|---|---|
| Market Demand | 235,000,000 | 235.00M |
| Average Selling Price | $1,000.00 | $1,000.00 |
| Market Demand ($) | $235,000,000,000 | $235.00B |
| Market Share | 3.00% | 3.00% |
| Sales ($) | $7,050,000,000 | $7.05B |
| Percent Margin | 25.00% | 25.00% |
| Gross Profit | $1,762,500,000 | $1.762B |
| Marketing Expenses | $1,000,000,000 | $1.00B |
| Marketing Profit | $.7625B | $762.50M |

As can be seen in the above table, editable cells 208 (“Input” column) may receive numeric and/or alphanumeric data and scale the data to a readable number. For example, the number input for “Sales” is $7,050,000,000. This number may be scaled to $7.05B (“B” stands for billion, “M” stands for million). Alphanumeric data, such as the “B” in the “Marketing Profit” row, may also be interpreted and scaled. In this example, the “B” is interpreted as billion, and thus, the $0.7625B is scaled to $762.50M, which is a more intuitive number than $0.7625B and more efficient than $762,500,000 with regard use of space and presentation.

The disclosure set forth above may encompass multiple distinct embodiments with independent utility. The specific embodiments disclosed and illustrated herein are not to be considered in a limiting sense, because numerous variations are possible. The subject matter of this disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

What is claimed is:

1. A computer-readable medium having a software application for individual learning and user-application of mathematical principles, the software application including computer-executable instructions to cause a computer to depict a dynamic graphical user interface comprising:
a virtual book with a plurality of ordered pages, where at least a first page is viewable and a second page is selected for viewing by turning pages of the plurality of ordered pages until the second page is viewable;
a plurality of cells on the first page for containing data, at least one of the plurality of cells being an editable cell; and
a chart that is based on the data that is contained in the plurality of cells.

2. The computer-readable medium of claim 1, wherein the first page includes a corner portion that is configured to transform visibly when a user moves a cursor over the portion; and the plurality of ordered pages are turned from the first page when the transformed corner portion is selected to simulate turning a page.

3. The computer-readable medium of claim 1, wherein the graphical user interface fluidly animates a change in the chart when a datum in the editable cell is changed.

4. The computer-readable medium of claim 1, wherein the graphical user interface provides the ability to select a portion of the entire first page and save the selected portion directly to an image file.

5. The computer-readable medium of claim 1, where the chart includes an inner dial with an inner indicator that is located at a position along the inner dial that is related to a first value in a first cell of the plurality of cells, and an outer dial with an outer indicator that is located at a position along the outer dial that is related to a second value in a second cell of the plurality of cells, wherein the inner and outer dials are concentric.

6. The computer-readable medium of claim 1, wherein the software application is configured to execute within a cross-platform runtime environment.

7. The computer-readable medium of claim 1, wherein the software application further includes computer-executable instructions to cause the computer to save current data to memory, the current data having been input into the editable cell during a current session, and to load previous data that was input in a previous session from memory.

8. The computer-readable medium of claim 7, wherein the software application further includes computer-executable instructions to cause the computer to, prior to saving current data input into the editable cell in the current session, prompt a user to provide one or more subsets of the current data which to save.

9. The computer-readable medium of claim 1, wherein the graphical user interface provides an ability to bookmark the first page so that when pages of the virtual book are turned away from the first page, the bookmark remains visible.

10. The computer-readable medium of claim 1, wherein the virtual book includes a third page that is located adjacent the first page when the first page is viewable, the third page including a tab that is selected to reveal a link to a network resource containing information about the first page.

11. The computer-readable medium of claim 1, wherein the software application further includes instructions to cause the computer to, upon entry of a first datum into the editable cell and a second datum of a different order than the first datum into a second editable cell, scale the first datum and the second datum to a common order.

12. The computer-readable medium of claim 1, wherein the plurality of pages are organized into pairs of pages, each pair relating to a different marketing metric.

13. The computer-readable medium of claim 1, wherein the data contained in the plurality of cells of the first page includes input marketing data, and the chart is configured to depict analysis information about output marketing metrics based upon the marketing data in the plurality of cells.

14. A virtual book for teaching, individual learning and simulating mathematical principles, the book being executable on a computer system and comprising:
means for depicting a first page of a plurality of pages;
means turning through the plurality of pages until a second page is depicted;
means for receiving data on the first page; and
means for charting the data received on the first page.

15. The virtual book of claim 14, wherein the means for charting is configured to:
depict an inner dial with an inner indicator that is located at a position along the inner dial that is related to a first value; and
depict an outer dial that is concentric with the inner dial, the outer dial including an indicator that is located at a position along the outer dial that is related to a second value.

16. The virtual book of claim 14, wherein the plurality of pages are organized into pairs of pages, each pair relating to a different marketing metric.

17. The virtual book of claim 16, wherein the data received on the first page is marketing data, and the means for charting is configured to depict information about marketing metrics based upon the marketing data.

18. The virtual book of claim 14, further comprising means for scaling a first datum and a second datum of different orders that are received on the first page to a common order.

19. A method for teaching and simulating mathematical principles, comprising:
depicting simultaneously on an electronic display two pages of a plurality of pages of a virtual book that resembles a tangible book;
receiving data on one of the two pages; and
charting the data received on the first page.

20. The method of claim 19, further comprising depicting information about a mathematical principle utilized on the one of the two pages on the other of the two pages, the information including a link to a network resource.
